(19) United States
(12) Patent Application Publication
(10) Pub. No.: US 2013/0024461 A1
(43) Pub. Date: Jan. 24, 2013

(54) SYSTEM AND METHOD FOR PROVIDING LOCATION-SENSITIVE AUTO-COMPLETE QUERY

(71) Applicants: Seung Jun Lee, Seongnam-si (KR); Taeil Kim, Seongnam-si (KR)

(72) Inventors: Seung Jun Lee, Seongnam-si (KR); Taeil Kim, Seongnam-si (KR)

(73) Assignee: NHN Corporation, Seongnam-si (KR)

(21) Appl. No.: 13/552,204

(22) Filed: Jul. 18, 2012

(30) Foreign Application Priority Data
Jul. 22, 2011 (KR) 10-2011-0072791

(51) Int. Cl. G06F 17/30

(52) U.S. Cl. 707/741; 707/E17.002; 707/E17.066

(57) ABSTRACT

Provided is a system and method for providing a location-sensitive auto-complete query. The system includes at least one processor; a memory to store at least one program configured to be executed by the at least one processor; a keyword generating unit to generate a keyword based on the query inputted from a user terminal and location information received from the user terminal; and a query providing unit to provide an auto-complete query corresponding to the generated keyword among the auto-complete queries indexed according to location information.

### CROSS-REFERENCE TO RELATED APPLICATION

This application claims priority from and the benefit of Korean Patent Application No. 10-2011-0072791, filed on Jul. 22, 2011, which is hereby incorporated by reference for all purposes as if fully set forth herein.

### BACKGROUND

1. Field

Exemplary embodiments of the present invention relate to a system and method for providing a location-sensitive auto-complete query in response to a user's query for information search.

2. Discussion of the Background

Generally, a search website provides a search service by providing a user with a search result in response to the user's search term, such as, for example, a website including the query, an article including the query, an image with a file name including the query, and the like.

Currently, research is being made to develop a search service to provide a user with a satisfactory search result even when the user inputs an improper or insufficient query, as well as when the user inputs a proper query, in order to enhance user convenience.

Reference is made herein to Korean Patent Application No. 10-2005-0040852, which has matured to registration, entitled a “system and method for providing an auto-complete query and computer readable recording medium recording program for implementing the method” in which an auto-complete query may be provided by suggesting a query suitable for a query input condition of a user in real time to prevent the user from misspelling a query for which a search is to be conducted.

When an auto-complete query is provided according to the foregoing method, a satisfactory auto-complete query may be generally provided to a user, but when the user intends to find a result for a desired query based on a location, for example, when the user intends to find restaurant information or shopping mall information for a region in which the user is located, there is a need for providing a location-sensitive auto-complete query based on the user's location, to better serve the user's need.

However, in order to provide a location-sensitive auto-complete query, a system for a location-sensitive auto-complete query is needed.

The above information disclosed in this Background section is only for enhancement of understanding of the background of the invention, and therefore, it may contain information that does not form any part of the prior art nor what the prior art may suggest to a person of ordinary skill in the art.

### SUMMARY

Accordingly, exemplary embodiments of the present invention provide a system and method for providing a location-sensitive auto-complete query that may provide a location-sensitive auto-complete query with the user based on the user's location.

Exemplary embodiments of the present invention also provide a system and method for providing a location-sensitive auto-complete query that may provide a location-sensitive auto-complete query using a system for providing an auto-complete query.

Additional features of the invention will be set forth in the description which follows, and in part will be apparent from the description, or may be learned by practice of the invention.

An exemplary embodiment of the present invention discloses a system for providing an auto-complete query for a query inputted by a user, the system including at least one processor; a memory to store at least one program configured to be executed by the at least one processor; a keyword generating unit to generate a keyword based on the query inputted from a user terminal and location information received from the user terminal; and a query providing unit to provide an auto-complete query corresponding to the generated keyword among the auto-complete queries indexed according to location information.

Another exemplary embodiment of the present invention discloses a method for providing an auto-complete query for a query inputted by a user, the method including generating a keyword by the at least one processor based on the query inputted from a user terminal and location information received from the user terminal; and providing an auto-complete query corresponding to the generated keyword among the auto-complete queries indexed according to location information.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram illustrating a system for providing a location-sensitive auto-complete query according to an exemplary embodiment of the present invention.

FIG. 2 is a diagram illustrating operation of a system for providing a location-sensitive auto-complete query according to an exemplary embodiment of the present invention.

FIG. 3 is a diagram illustrating examples of auto-complete queries indexed by a system for providing a location-sensitive auto-complete query according to an exemplary embodiment of the present invention.

FIG. 4 is a diagram illustrating examples of auto-complete queries provided when a user is located in a city according to an exemplary embodiment of the present invention.

FIG. 5 is a diagram illustrating examples of auto-complete queries provided when a user is located in a provincial area according to an exemplary embodiment of the present invention.

FIG. 6 is a flowchart illustrating a method for providing a location-sensitive auto-complete query according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. In the drawings, like numbers refer to the same or similar functionality throughout the several views. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

It will be understood that when an element is referred to as being “connected to” another element, it can be directly connected to the other element, or intervening elements may be present.

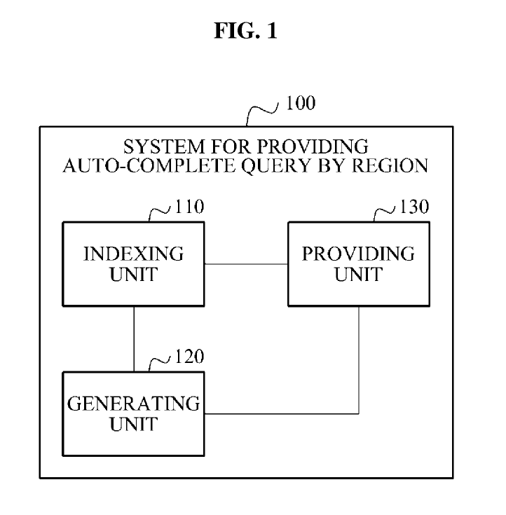

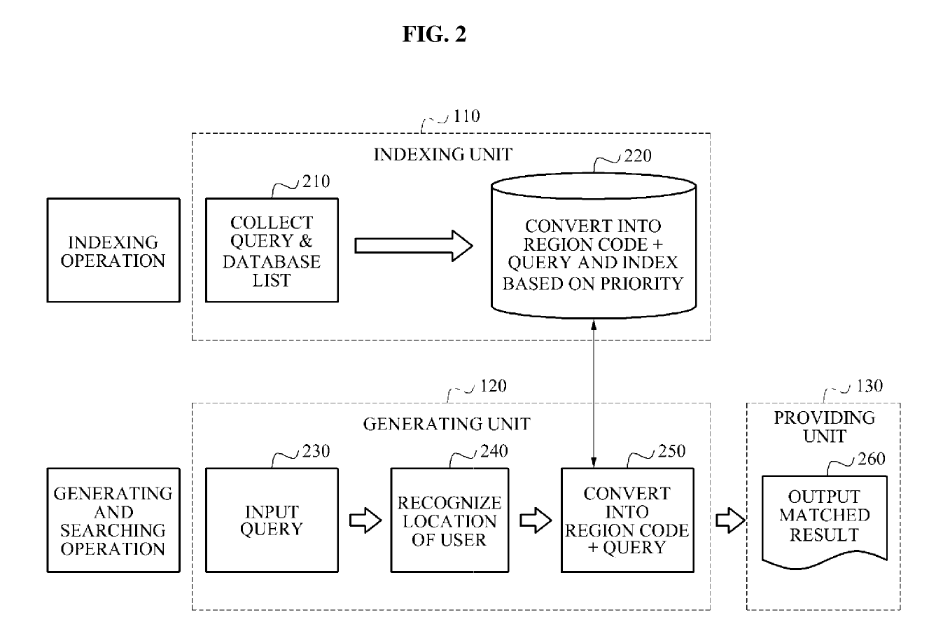

FIG. 1 is a block diagram illustrating a system 100 for providing a location-sensitive auto-complete query according to an exemplary embodiment of the present invention. FIG. 2 is a diagram illustrating the operation of the system 100 for providing a location-sensitive auto-complete query according to an exemplary embodiment of the present invention. Hereinafter, the system 100 for providing a location-sensitive auto-complete query is described with reference to FIG. 1 and FIG. 2.

The system 100 for providing a location-sensitive auto-complete query may obtain location information of a user terminal when a user inputs a query through a web browser installed on the user terminal. The system 100 for providing a location-sensitive auto-complete query may receive the query inputted by the user and may provide the user with an auto-complete query associated with the query based on the location information of the user terminal.

The system 100 for providing a location-sensitive auto-complete query may include a query indexing unit 110, a keyword generating unit 120, and a query providing unit 130.

The query indexing unit 110 may incorporate location information of the user terminal into an auto-complete query that is provided as a complete query for the query inputted by the user, so as to index the auto-complete query. That is, the query indexing unit 110 may incorporate location information of the user terminal into an auto-complete query using at least one of the queries collected by region and information about a content including the location information of the user terminal.

For example, the query indexing unit 110 may collect the queries inputted by user terminals into the system 100 for providing a location-sensitive auto-complete query and a database list including location information created in a variety of portal sites, and may use the query and the location information as the auto-complete query in operation 210. In this instance, the query indexing unit 110 may classify the query and the list by the unit of a grapheme, a syllable, or a suffix. For example, a query “donkey” may be indexed by units of graphemes, for example, “d”, “do”, “don”, “donk”, “donke”, and “donkey”, and by units of syllables, for example, “don” and “donkey”. Also, the query “donkey” may be indexed by suffixes, for example, “key” and “donkey”.

Also, the query indexing unit 110 may incorporate a region code as an example of location information of the user terminal into a corresponding auto-complete query and may index the auto-complete query having the incorporated region code based on priority, for example, in a search frequency, a bidding amount, and the like, in operation 220. Here, the location information may be used to classify the location-sensitive auto-complete query in order to identify a region in which the user is located. Accordingly, in the exemplary embodiments of the present invention, the location information of the user terminal incorporated into the auto-complete query is not limited to the region code and may include any information used to identify the region.

The keyword generating unit 120 may generate a keyword based on the query inputted from the user terminal and location information of the user terminal. Here, the location information may be inputted from the user terminal, or may be generated based on at least one of a browser cookie and an Internet Protocol (IP) address of the user terminal.

As an example, the keyword generating unit 120 may receive input information including the query of the user or a setting mode from a web browser installed on the user terminal in operation 230. In this case, the user may select at least one indexing method among grapheme indexing, syllable indexing, and suffix indexing, or may set location information of the user. However, when the user fails to set location information of the user, the keyword generating unit 120 may automatically recognize location information of the user based on the IP address of the user terminal, or may recognize location information of the user by identifying user profile information of a browser cookie in operation 240. The user profile information may include a gender, an age, a region, and the like, as user information in accordance with a system of demographic classification.

When the location information of the user is recognized in this manner, the keyword generating unit 120 may incorporate a region code corresponding to the location information into the inputted query to generate a keyword for searching for a location-sensitive auto-complete query that is to be provided to the user among a plurality of auto-complete queries stored in the query indexing unit 110 in operation 250.

For example, when a query “terminal” is inputted by a user located in a city, for example, Seoul, the keyword generating unit 120 may generate a keyword “01_terminal” by incorporating a region code for Seoul “01”.

The query providing unit 130 may provide the user terminal with an auto-complete query corresponding to the keyword generated by the keyword generating unit 120 among the auto-complete queries indexed by the query indexing unit 110.

For example, the query providing unit 130 may search for an auto-complete query matched to the keyword with the incorporated region code that has been generated by the keyword generating unit 120 among a plurality of auto-complete queries indexed by the query indexing unit 110. Also, the query providing unit 130 may output a predetermined number of previously found auto-complete queries at the bottom of a search window of a web browser in operation 260. In this case, the query providing unit 130 may determine the ranks of the auto-complete queries to be outputted, based on, for example, a search frequency, a bidding amount, and the like.

Further, although not shown, a system for providing a location-sensitive auto-complete query according to another exemplary embodiment of the present invention may include a keyword generating unit to generate a keyword based on a query inputted from a user terminal and location information of the user terminal, and a query providing unit to provide an auto-complete query corresponding to the keyword among auto-complete queries indexed by incorporating location information. In this case, the query providing unit may provide the keyword generated by the keyword generating unit to a separate information provider that classifies the query by region, and then may receive a query corresponding to the keyword from the information provider and provide the user with the query, or may receive the query classified by region from the information provider and provide the user with a query matched to the keyword.

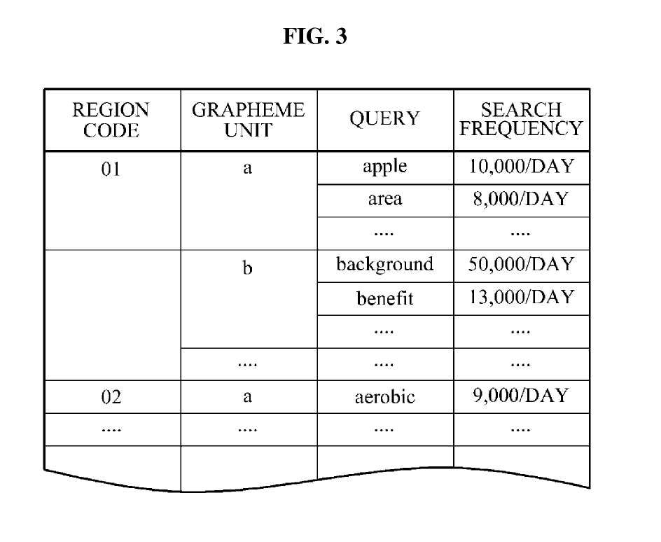

FIG. 3 is a diagram illustrating examples of auto-complete queries indexed by the system for providing a location-sensitive auto-complete query according to an exemplary embodiment of the present invention.

The query indexing unit 110 may index an auto-complete query by incorporating a region code into the auto-complete query. Also, the query indexing unit 110 may classify the auto-complete query in units of graphemes, syllables, or suffixes, and may index the auto-complete query in a descending order based on priority, for example, in an order of search frequency, an order of a bidding amount, and the like.

In FIG. 3, classification by the unit of a grapheme and search frequency-based indexing for an auto-complete query is illustrated as an example. Assuming that a region code ‘01’ represents a city, for example, Seoul and a region code ‘02’ indicates a provincial area, for example, Gyeonggi Province, when a user located in Seoul inputs ‘a’ as a query, the keyword generating unit 120 may convert the query ‘a’ into a keyword ‘01_a’. Using the keyword, the query providing unit 130 may provide auto-complete queries ‘apple’, ‘area’, and the like as a location-sensitive auto-complete query among auto-complete queries indexed as shown in FIG. 3. In this example, the query providing unit 130 may output a predetermined number of auto-complete queries by region in a descending order of search frequency at a bottom of a search window of a web browser. As another example, when a user located in Gyeonggi Province inputs ‘a’ as a query, the keyword generating unit 120 may convert the query ‘a’ into a keyword ‘02_a’. In this example, since ‘aerobic’ has a high search frequency, the query providing unit 130 may provide the user with ‘aerobic’ and the like as a location-sensitive auto-complete query. Accordingly, the system for providing a location-sensitive auto-complete query according to the exemplary embodiment of the present invention may provide the user with a location-sensitive auto-complete query.

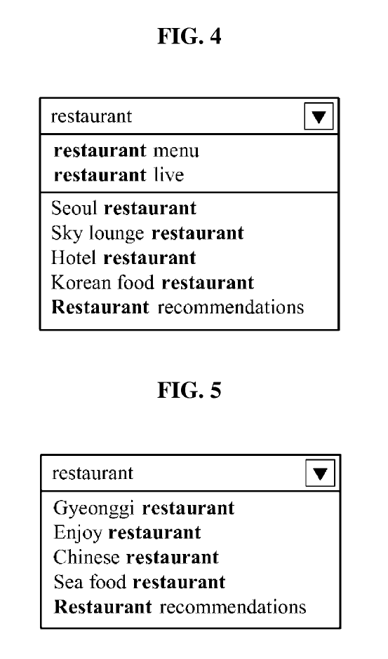

FIG. 4 is a diagram illustrating examples of auto-complete queries provided when a user is located in a city according to an exemplary embodiment of the present invention. FIG. 5 is a diagram illustrating examples of auto-complete queries provided when a user is located in a provincial area according to an exemplary embodiment of the present invention. The auto-complete query provided according to the present invention is described herein with reference to FIG. 4 and FIG. 5.

When a user who is located in a city such as Seoul or selects Seoul as location information of the user inputs a query “restaurant”, the system 100 for providing a location-sensitive auto-complete query may provide the user with auto-complete queries for “restaurant” located in Seoul as shown in FIG. 4. When a user who is located in a provincial area such as Gyeonggi Province or selects Gyeonggi Province as location information of the user inputs a query “restaurant”, the system 100 for providing a location-sensitive auto-complete query may provide the user with auto-complete queries for “restaurant” located in Gyeonggi Province as shown in FIG. 5. Accordingly, when a user intends to find a restaurant closest to a current location of the user, even though the user inputs an improper or insufficient query, the system 100 for providing a location-sensitive auto-complete query may automatically complete a query suitable for the intent of the user and may provide the user with the location-sensitive auto-complete query. Thus, the user may obtain a satisfactory search result using a query of interest or a query determined to be suitable among auto-complete queries provided through the system 100 for providing a location-sensitive auto-complete query.

Although FIG. 4 and FIG. 5 show a region classified by a city and a province, for example, Seoul and Gyeonggi Province, the system for providing a location-sensitive auto-complete query according to the present invention may provide an auto-complete query by a district, for example, “Gangnam-gu”, “Seocho-gu”, and the like, and may further provide an auto-complete query by a town such as, for example, “Cheongdam-dong”, “Nonhyeon-dong”, and the like.

The system for providing a location-sensitive auto-complete query according to the present invention may display a location-sensitive auto-complete query in a descending order of search frequency or bidding amount when providing a user with the location-sensitive auto-complete query. Also, the system for providing a location-sensitive auto-complete query according to the present invention may provide a general auto-complete query irrespective of the location of the user in a predetermined portion of an auto-complete query output area as well as providing a location-sensitive auto-complete query as shown in FIG. 2.

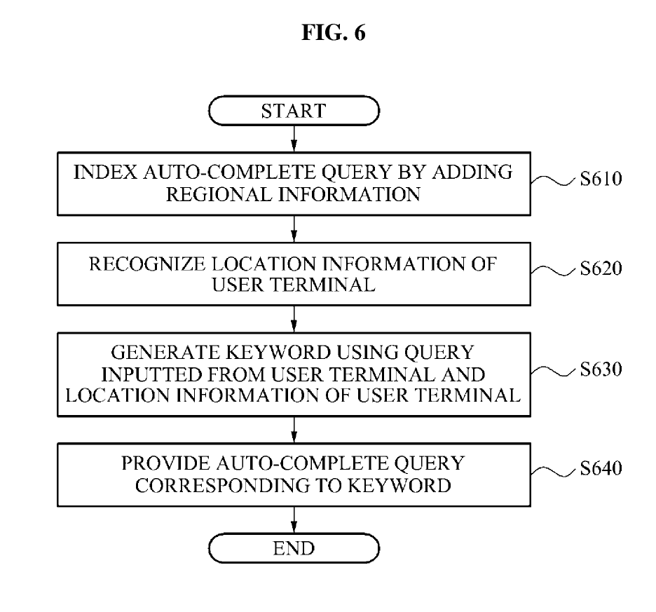

FIG. 6 is a flowchart illustrating a method for providing a location-sensitive auto-complete query according to an exemplary embodiment of the present invention.

In operation 610, when a user inputs a query, the system for providing a location-sensitive auto-complete query according to an exemplary embodiment of the present invention may index an auto-complete query by incorporating location information of the user terminal into the auto-complete query using the query collected by region and information about a content including the location information of the user terminal. In this instance, the auto-complete query may be classified by in units of graphemes, syllables, or suffixes, and may be indexed based on priority, for example, in order of a search frequency, a bidding amount, and the like. The location information may be manually set by the user through the user terminal on, for example, the web browser that the user uses. In such instance, if the user manually enters his desired location, for example, “Seoul”, the system for providing a location-sensitive auto-complete query will return search results based on the user-inputted location information.

Subsequently, in operation 620, when a user terminal accesses the system for providing a location-sensitive auto-complete query, the system for providing a location-sensitive auto-complete query may recognize location information of the user terminal. Here, the location information may be inputted from the user terminal, or may be recognized using information for identifying the user terminal, such as, for example, a browser cookie and the IP address of the user terminal, as described with reference to FIG. 1.

When the location information of the user terminal is recognized in this manner, in operation 630, the system for providing a location-sensitive auto-complete query may generate a keyword for searching for a location-sensitive auto-complete query to be provided to the user using the query inputted from the user terminal and the recognized location information of the user terminal.

In operation 640, the system for providing a location-sensitive auto-complete query may extract a predetermined number of auto-complete queries matched to the keyword from a plurality of auto-complete queries indexed using the keyword, and may provide the auto-complete queries to the user terminal through a web browser based on the priority.

Accordingly, the system and method for providing an location-sensitive auto-complete query according to the present invention may provide an auto-complete query in real time based on a region in which a user is located using location information of a user terminal when the user inputs a query into a search window of a web page, and may provide an location-sensitive auto-complete query with one system for providing an auto-complete query.

The method for providing an location-sensitive auto-complete query according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media such as CD ROM discs and DVD; magneto-optical media such as floppy discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

According to the exemplary embodiments of the present invention, an auto-complete query may be provided based on a region in which a user is located, by incorporating location information into auto-complete queries to index the auto-complete queries and providing an auto-complete query using location information of a user terminal when the user inputs a query. According to the exemplary embodiments of the present invention, a location-sensitive auto-complete query may be provided using one system for providing an auto-complete query, thereby reducing the costs involved in construction of the system.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system for providing an auto-complete query for a query inputted by a user, the system comprising:
at least one processor;
a memory to store at least one program configured to be executed by the at least one processor;
a keyword generating unit to generate a keyword based on the query inputted from a user terminal and location information received from the user terminal; and
a query providing unit to provide an auto-complete query corresponding to the generated keyword among the auto-complete queries indexed according to location information.

2. The system of claim 1, wherein the location information received from the terminal comprises at least one of a browser information, an Internet Protocol (IP) address of the user terminal, and input information.

3. The system of claim 1, further comprising:
a query indexing unit to index auto-complete queries by incorporating the location information into the auto-complete queries.

4. The system of claim 3, wherein the query indexing unit is configured to index the auto-complete queries by incorporating the location information into the auto-complete queries using at least one of the queries collected by region and information about a content including the location information.

5. The system of claim 3, wherein the query indexing unit is configured to incorporate each corresponding region code to the auto-complete queries and index the auto-complete queries having the incorporated region codes based on priority.

6. The system of claim 5, wherein the keyword generating unit is configured to generate the keyword by incorporating a region code corresponding to the location information into the inputted query.

7. The system of claim 5, wherein the query providing unit is configured to provide the auto-complete query corresponding to the generated keyword among the indexed auto-complete queries based on the priority.

8. A method for providing an auto-complete query for a query inputted by a user, the method being performed by at least one processor, the method comprising:
generating a keyword by the at least one processor based on the query inputted from a user terminal and location information received from the user terminal; and
providing an auto-complete query corresponding to the generated keyword among the auto-complete queries indexed according to location information.

9. The method of claim 8, wherein the location information received from the terminal comprises at least one of a browser information, an Internet Protocol (IP) address of the user terminal, and input information.

10. The method of claim 8, further comprising:
indexing the auto-complete queries by incorporating the location information into the auto-complete queries.

11. The method of claim 10, wherein the indexing comprises:
indexing the auto-complete queries by incorporating the location information into the auto-complete queries using at least one of the queries collected by region and information about a content including the location information.

12. The method of claim 10, wherein the indexing comprises:
incorporating each corresponding region code into the auto-complete queries; and
indexing the auto-complete queries having the incorporated region codes based on priority.

13. The method of claim 12, wherein the generating comprises incorporating a region code corresponding to the location information into the inputted query to generate the keyword.

14. The method of claim 12, wherein the providing comprises providing the auto-complete query corresponding to the generated keyword among the indexed auto-complete queries based on the priority.

15. A non-transitory computer-readable medium comprising instructions for controlling to provide an auto-complete query for a query inputted by a user, the instructions being executed by a method including:
generating a keyword based on the query inputted from a user terminal and location information received from the user terminal; and
providing an auto-complete query corresponding to the generated keyword among the auto-complete queries indexed according to location information.
